(19) United States
(12) Patent Application Publication
(10) Pub. No.: US 2014/0376726 A1
(43) Pub. Date: Dec. 25, 2014

(54) STEREO HEADPHONE AUDIO PROCESS

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/185,038

(22) Filed: Feb. 20, 2014

Related U.S. Application Data
(60) Provisional application No. 61/767,199, filed on Feb. 20, 2013.

(51) Int. Cl. H04S 3/00

(52) U.S. Cl. CPC H04S 3/006; H04S 2400/01
USPC 381/19

(57) ABSTRACT

A process and system for enhancing and customizing sound includes receiving an input audio sound and enhancing the voice audio input in two or more harmonic and dynamic ranges by re-synthesizing the audio into a full range PCM wave. A tone adjusting circuit is provided which includes a first section for adjusting a low frequency tone, a second section for adjusting a mid frequency tone, a third section for adjusting a high frequency tone and mixing the audio outputs processed by the first, second and third sections to produce an output audio sound. The enhancement includes the parallel processing the input audio via a low pass filter with dynamic offset, an envelope controlled bandpass filter, a high pass filter, adding an amount of dynamic synthesized sub bass to the audio and combining the four treated audio signals in a summing mixer with the original audio. The low frequency tone has a frequency of 100 Hz and a bandwidth of 0.5. The mid frequency tone has a frequency of 2500 Hz and an adjustable bandwidth and the high frequency tone has a frequency of 10 KHz and an adjustable bandwidth.

Embodiments of the present invention relate to U.S. Provisional Application Ser. No. 61/767,199, filed Feb. 20, 2013, entitled “STEREO HEADPHONES”, the contents of which are incorporated by reference herein and which is a basis for a claim of priority.

### BACKGROUND OF THE INVENTION

Headphones (or “head-phones” in the early days of telephony and radio) are a pair of small loudspeakers that are designed to be held in place close to a user's ears. They are also known as earspeakers, earphones or, colloquially, cans. The alternate in-ear versions are known as earbuds or earphones. In the context of telecommunication, a headset is a combination of headphone and microphone. Headphones either have wires for connection to a signal source such as an audio amplifier, radio, CD player, portable media player, mobile phone, electronic musical instrument, or have a wireless device, which is used to pick up signal without using a cable.¹ ¹ http://en.wikipedia.org/wiki/Stereo_headphones

Stereo headphones are available in various quality and price grades, many of the lower price and quality versions suffer from distortions, often resulting in the user having to turn the audio louder to hear all of the parts in the audio and other hearing detrimental practices.

In sound recording and reproduction, equalization is the process commonly used to alter the frequency response of an audio system using linear filters. Most hi-fi equipment uses relatively simple filters to make bass and treble adjustments. Graphic and parametric equalizers have much more flexibility in tailoring the frequency content of an audio signal. An equalizer is the circuit or equipment used to achieve equalization. Since equalizers, adjust the amplitude of audio signals at particular frequencies, they are, in other words, frequency-specific volume knobs.² ² http://en.wikipedia.org/wiki/Equalization_(audio)

Equalizers are used in recording studios, broadcast studios, and live sound reinforcement to correct the response of microphones, instrument pick-ups, loudspeakers, and hall acoustics. Equalization may also be used to eliminate unwanted sounds, make certain instruments or voices more prominent, enhance particular aspects of an instrument's tone, or combat feedback (howling) in a public address system. Equalizers are also used in music production to adjust the timbre of individual instruments by adjusting their frequency content and to fit individual instruments within the overall frequency spectrum of the mix.³ ³ See, n.1, above

The most common equalizers in music production are parametric, semi-parametric, graphic, peak, and program equalizers. Graphic equalizers are often included in consumer audio equipment and software which plays music on home computers. Parametric equalizers require more expertise than graphic equalizers, and they can provide more specific compensation or alteration around a chosen frequency. This may be used in order to remove (or to create) a resonance, for instance. ⁴ ⁴ See, n.1, above

Tone control is a type of equalization used to make specific pitches or “frequencies” in an audio signal softer or louder. A tone control circuit is an electronic circuit that consists of a network of filters which modify the signal before it is fed to speakers, headphones or recording devices by way of an amplifier.

Conventional tone control method is thus a static setting that can increase or decrease a fixed amount at a single frequency and bandwidth. While this does allow the user to customize a sound to his preference, as soon as anything changes this setting may not be desirable and the user will either accept compromise or be continually changing the amounts as different content is played.⁵ ⁵ http://en.wikipedia.org/wiki/Tone_control_circuit

Sound quality is typically an assessment of the accuracy, enjoyability, or clarity of audio output from an electronic device. Quality can be measured objectively, such as when tools are used to measure a certain aspect of quality with which the device reproduces an original sound; or it can be measured subjectively, such as when human listeners respond to the sound or gauge its perceived similarity to another sound.⁶ ⁶ http://en.wikipedia.org/wiki/Sound_quality

The sound quality of a reproduction or recording depends on a number of factors, including the equipment used to make it, processing and mastering done to the recording, the equipment used to reproduce it, as well as the listening environment used to reproduce it. In some cases, processing such as equalization, dynamic range compression or stereo processing may be applied to a recording to create audio that is significantly different from the original but may be perceived as more agreeable to a listener. In other cases, the goal may be to reproduce audio as closely as possible to the original.⁷ See, n.1, above.

When applied to specific electronic devices, such as loudspeakers, microphones, amplifiers or headphones sound quality usually refers to accuracy, with higher quality devices providing higher accuracy reproduction. When applied to processing steps such as mastering recordings, absolute accuracy may be secondary to artistic or aesthetic concerns. In still other situations, such as recording a live musical performance, audio quality may refer to proper placement of microphones around a room to optimally use room acoustics.⁸ ⁸ See, n1, above.

Human voice has a frequency range that extends from 80 Hz to 14 kHz. However, traditional, voice band or narrowband telephone calls limit audio frequencies to the range of 300 Hz to 3.4 kHz. As a result, when humans communicate over telephone lines, there is resulting loss of quality in the voice heard through phone lines due to the loss in the frequency range.

Accordingly, communication devices, such as cellular phones, which rely on limited narrow band widths, have transmission that is very limited in its audio range. Due to this limitation in the available frequency range, manufacturers of telephonic communication devices will only make devices that operate within this criteria. As an example, cell phone manufacturers would not manufacture a full 20 to 20 kHz audio capable phone, as it would not cost efficient since the improvement could not be above what the transmission is capable of.

Due to the limited range of available bandwidth, telecommunication devices that rely on such bandwidth, such as cell phones, utilize electronics and circuitry that have a very narrow frequency range. This limited range results in anything from degraded to garbled voice quality on the receiving user.

There is a need for an application that addresses the above deficiencies of existing systems that can add clarity to receive audio.

### SUMMARY OF THE INVENTION

The inventive process and system for enhancing and customizing sound includes receiving an input audio sound and enhancing the voice audio input in two or more harmonic and dynamic ranges by re-synthesizing the audio into a full range PCM wave. A tone adjusting circuit is provided which includes a first section for adjusting a low frequency tone, a second section for adjusting a mid frequency tone, a third section for adjusting a high frequency tone and mixing the audio outputs processed by the first, second and third sections to produce an enhanced output audio sound.

The inventive audio enhancement process includes the parallel processing the input audio via a low pass filter with dynamic offset, an envelope controlled bandpass filter, a high pass filter, adding an amount of dynamic synthesized sub bass to the audio and combining the four treated audio signals in a summing mixer with the original audio. The low frequency tone has a frequency of 100 Hz and a bandwidth of 0.5. The mid frequency tone has a frequency of 2500 Hz and an adjustable bandwidth and the high frequency tone has a frequency of 10 KHz and an adjustable bandwidth.

### BRIEF DESCRIPTION OF THE DRAWINGS

FIG. 1 is a block diagram of an embodiment of the audio process of the present invention.

FIG. 2 shows a typical use/implementation of the inventive Stereo Processor according to an embodiment of the present invention.

FIG. 3 shows a flow chart of the inventive Wave Adjustment Tool according to an embodiment of the present invention.

### DETAILED DESCRIPTION OF THE PREFERRED EMBODIMENT(S)

The inventive process of the present application includes two stages, a Stereo Processing module and a tone adjustment module (WAT). Implementing the inventive process into any headphones, results in an increase in the harmonic and dynamic range of these headphones. Since the process is dynamic in its control method, it also eliminates many of the phase anomalies that occur in normal unprocessed headphones. This will make them more efficient and much clearer sounding with the same hardware.

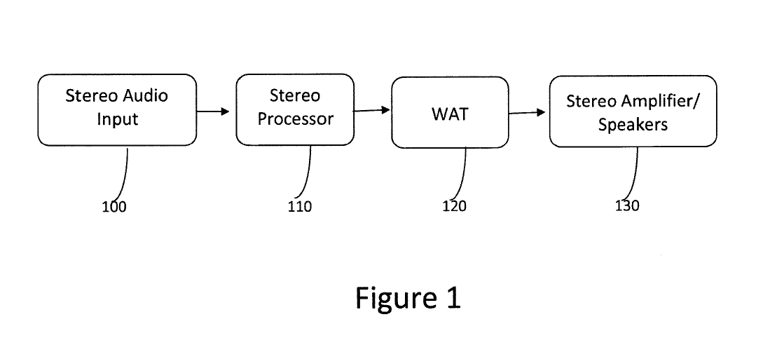

In one embodiment, the stereo headphones in which the inventive process is implemented are powered and have a processor for processing the inventive processes built into them. In one embodiment, the audio input is provided by an external device, such as a CD or MP3 player. When the audio is input into this device there is typically an input level control that controls the gain or volume of the entire unit. The audio path is, e.g., as shown in FIG. 1 with the audio ending at the transducers or speakers for user listening.

Following the processing of the audio input by the stereo processor module, the processed sound is fed to the inventive Wave Adjustment Tool (WAT), which includes controls available for the user to adjust the tonality of the audio to his/her liking. For example, the controls are LOW, MID, and HIGH. These controls can be located on one side of the headphone unit. The tone control is an improvement over the conventional tone adjustments in part because it is based on a dynamic approach that monitors the content of the received audio and adjusts itself to compensate for any changes in both a positive and negative direction. The end result is very pleasing and a more natural sound of the content being played. The WAT is not limited only three bands. More dynamic bands may be added as desired by programming them into the process and assigning the frequency, band width, and amount of dynamic change to be allowed per band. In this case it is a digital process, but it may be hardware (analog) if desired in any output format (mono, stereo, 5.1, 7.1, etc.)

The details of the present invention will now be further explained by reference to the drawings.

Referring to FIG. 1, stereo audio input 100 is audio form an external device source (not shown) such as a CD or MP3 player. Audio input 100 is fed to the inventive Stereo Processor 110 for processing. The processing results in an increase in the harmonic and dynamic range of these headphones. Since the process is dynamic in its control method, it also eliminates many of the phase anomalies that occur in normal unprocessed headphones. This will make them more efficient and much clearer sounding with the same hardware. Sound processed by the inventive Stereo Processor 110 is fed to the inventive WAT (Wave Adjustment Tool) 120, which includes controls available for the user to adjust the tonality of the audio to user's liking, and is then outputted to the speakers 130.

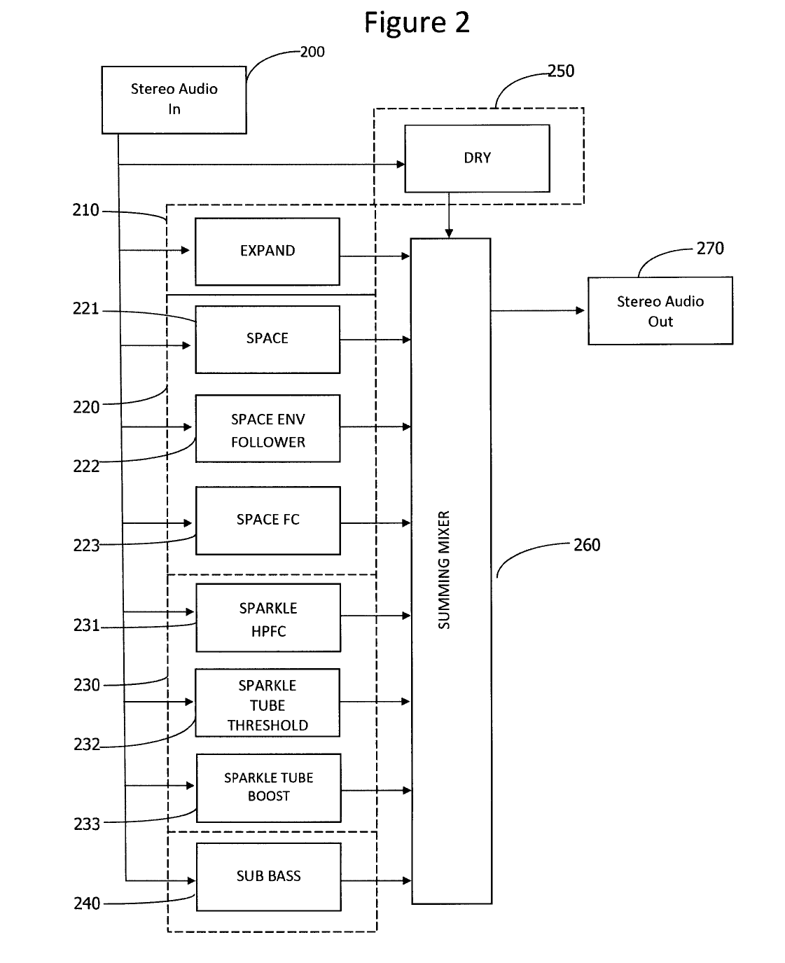

Further details of the inventive Stereo Processor will now be described with reference to FIG. 2. Stereo Audio input 200 is processed, in parallel, by several module as follows. EXPAND 210 is preferably a 4 pole digital low pass filter with an envelope follower for dynamic offset (fixed envelope follower). This allows the output of the filter to be dynamically controlled so that the output level is equal to whatever the input is to this filter section. For exaple, if the level at the input is −6 dB, then the output will match that. Moreover, whenever there is a change at the input, the same change will occur at the output regardless of either positive or negative amounts. The frequency for this filter is, e.g., 20 to 20 k hertz, which corresponds to a full range. In one embodiment, the purpose of EXPAND 310 is to “warm up” or provide a fuller sound as waveform 100 passes through it. The original audio 200 passes through, and is added to the effected sound for its output. As the input amount varies, so does the phase of this section. This applies to all filters used in this software application. Preferably all filters are of the Butterworth type.

Next, we discuss SPACE 220. SPACE 220 refers to the block of three modules identified by reference numerals 221, 222 and 223. The first module SPACE 221—which follows EXPAND 210 envelope follower, sets the final level of this module. This is the effected signal only, without the original. SPACE ENV FOLLOWER 222 tracks the input amount and forces the output level of this section to match. SPACE FC 223 sets the center frequency of the 4 pole digital high pass filter used in this section. This filter also changes phase as does EXPAND 210.

SPACE blocks 220 are followed by the SPARKLE 230 blocks. Like SPACE 220, there are several components to SPARKLE. SPARKLE HPFC 231 is a 2 pole high pass filter with a preboost which sets the lower frequency limit of this filter. Anything above this setting passes through the filter while anything below is discarded or stopped from passing. SPARKLE TUBE THRESH 232 sets the lower level at which the tube simulator begins working. As the input increases, so does the amount of the tube sound. The tube sound adds harmonics, compression and a slight bit of distortion to the input audio 200. This amount increases slightly as the input level increases. SPARKLE TUBE BOOST 233 sets the final level of the output of this module. This is the effected signal only, without the original.

Next, the SUB BASS 240 module is discussed. This module takes the input signal and uses a low pass filter to set the upper frequency limit to about 100 Hz. An octave divider occurs in the software that changes the input signal to lower by an octave (12 semi tones) and output to the only control in the interface, which is the level or the final amount. This is the effected signal only, without the original.

Outputs from the above modules 210 to 240 are directed into SUMMING MIXER 250 which combines the audio. The levels going into the summing mixer 250 are controlled by the various outputs of the modules listed above. As they all combine with the original signal 200 fed through the DRY 260 module there is interaction in phase, time and frequencies that occur dynamically. These changes all combine to create a very pleasing audio experience for the listener in the form of “enhanced” audio content. For example, a change in a single module can have a great affect on what happens in relation to the other modules final sound or the final harmonic output of the entire software application.

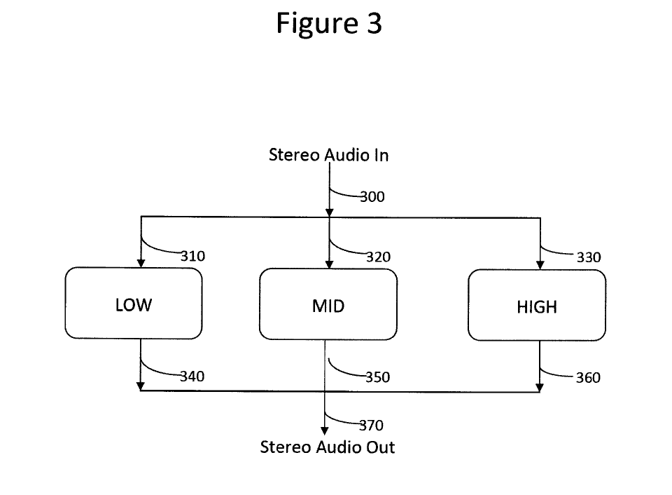

Continuing with reference to FIG. 3, output from the Stereo Processor of FIG. 2 is received for further processing by the Wave Adjustment Tool of the present invention for tone adjustment. Input audio 300 is processed in parallel by the three sections of the WAT tone adjusting circuit, which include the LOW 310, MID 320 and HIGH 330 sections. The audio processed by the three sections (shown by reference numerals 340, 350 and 360 in FIG. 2) are then mixed to form output audio 370.

According to one embodiment of the present invention the LOW section has a frequency of 100 Hz and a 0.5 bandwidth; MID has a frequency of 2500 Hz with an adjustable bandwidth; and HIGH has a 10 kHz frequency and a 0.5 bandwidth.

For MID, the center frequency is dynamically moved in both positive and negative amounts according to the input level of this bandpass filter. Preferably, the range is from 1.7 kHz on the low end to 4.5 kHz on the upper end with 2.5 kHz as the center or nominal setting. As the input level goes positive or negative, so the bandwidth will change. For a negative change the bandwidth will increase, for e.g., to a 0.5, while a positive change will decrease, for e.g., to a 0.1. This provides a larger frequency change for negative and a smaller, more precise change for positive level amounts in the filtered audio content.

In reference to the HIGH tone control section the center frequency is fixed, e.g., at 10 kHz, but the bandwidth changes dynamically in positive amounts as the input level changes. For negative amounts the bandwidth stays at, e.g., 0.5, when the level decreases the bandwidth goes only to a max bandwidth of e.g., 0.3.

What is claimed is:

1. A process and system for enhancing and customizing sound comprising:
Receiving an input audio sound;
Enhancing the voice audio input in two or more harmonic and dynamic ranges by re-synthesizing the audio into a full range PCM wave;
A tone adjusting circuit, comprising;
A first section for adjusting a low frequency tone;
A second section for adjusting a mid frequency tone;
A third section for adjusting a high frequency tone
Mixing the audio outputs processed by the first, second and third sections to produce an output audio sound.

2. The process of claim 1, wherein the enhancement includes the parallel processing the input audio as follows:
A module that is a low pass filter with dynamic offset;
An envelope controlled bandpass filter;
A high pass filter;
Adding an amount of dynamic synthesized sub bass to the audio;
Combining the four treated audio signals in a summing mixer with the original audio.

3. The process of claim 2, wherein the low frequency tone has a frequency of 100 Hz and a bandwidth of 0.5.

4. The process of claim 2, wherein the mid frequency tone has a frequency of 2500 Hz and an adjustable bandwidth.

5. The process of claim 2, wherein the high frequency tone has a frequency of 10 KHz and an adjustable bandwidth.

6. The process of claim 2 wherein the wireless communication device is a cellular phone.

7. The process of claim 2 wherein the enhancement includes resynthesizing audio to an increased harmonic and dynamic range than original values.
